(19) United States
(12) Patent Application Publication
(10) Pub. No.: US 2026/0324615 A1
(43) Pub. Date: Oct. 22, 2026

(54) INSECT DETECTION SYSTEM, INSECT DETECTION METHOD, COMPUTER, AND COMPUTER PROGRAM

(71) Applicant: FutuRocket Co., Ltd., Tokyo (JP)

(72) Inventor: Hiroumi MITANI, Tokyo (JP)

(21) Appl. No.: 19/557,777

(22) Filed: Mar. 5, 2026

(30) Foreign Application Priority Data
Mar. 13, 2025 (JP) 2025-039997

(51) Int. Cl. A01M 1/24; A01M 31/00; G01J 5/00; G01J 5/02; G01J 5/03

(52) U.S. Cl. CPC A01M 1/24; A01M 31/002; G01J 5/0025; G01J 5/0066; G01J 5/027; G01J 5/03; A01M 2200/011; G01J 2005/0077

(57) ABSTRACT

Provided is an insect detection system (1) which includes a heat mat (300), an infrared camera (200), and a computer (100). The infrared camera has a plurality of pixels. The infrared camera is directed toward the heat mat. The computer detects the presence of an insect based on a temperature distribution of the plurality of pixels acquired from the infrared camera.

### TECHNICAL FIELD

The present invention relates to a insect detection system, a insect detection method, a computer, and a computer program for detecting the presence of insects.

### BACKGROUND ART

Conventionally, techniques for detecting the presence of insects using cameras or sensors have been known. For example, Japanese Patent Application Laid-Open No. 2019-83786 (Patent Document 1) discloses a monitoring system. According to Patent Document 1, a monitoring system includes a sensor and a specifying unit. The sensor detects predetermined information other than a person by using illumination light emitted from a detection lighting device. The specifying unit specifies a particular target object, such as a harmful insect or harmful animal, that is present within the sensing range of the sensor based on sensor information detected by the sensor. Furthermore, a generation unit generates data indicating a movement path of the target object based on a floor layout diagram and the specified position of the target object. In addition, the specifying unit can identify the target object based on its response to a stimulus.

### CITATION LIST

### Patent Literature

PTL 1: Japanese Patent Application Publication No. 2019-83786 A

### SUMMARY OF INVENTION

### Technical Problem

An object of the present invention is to provide a technique for efficiently detecting the presence of insects having a low body temperature, such as cockroaches.

### Solution to the Problem

According to an aspect of the present invention, there is provided an insect detection system including a heat mat, an infrared camera, and a computer. The infrared camera has a plurality of pixels. The infrared camera is pointed at the heat mat. The computer detects the presence of an insect based on a distribution of temperatures of the plurality of pixels acquired from the infrared camera.

### ADVANTAGEOUS EFFECTS OF INVENTION

According to the present invention, there is provided a technique capable of efficiently detecting the presence of insects having relatively low body temperatures, such as cockroaches.

### BRIEF DESCRIPTION OF THE DRAWINGS

FIG. 1 is a schematic diagram illustrating an overall configuration of an insect detection system according to First embodiment.

FIG. 2 is a block diagram illustrating a structure of an infrared camera according to First embodiment.

FIG. 3 is a block diagram illustrating a structure of a control computer according to First embodiment.

FIG. 4 is a photograph showing an experimental scene in which a cockroach is detected from an infrared image according to First embodiment.

FIG. 5 is a flowchart illustrating information processing performed by the control computer according to First embodiment.

FIG. 6 is a schematic diagram illustrating an overall configuration of an insect detection system according to Second embodiment.

FIG. 7 is a schematic diagram illustrating an overall configuration of an insect detection system according to Third embodiment.

FIG. 8 is a schematic diagram illustrating an overall configuration of another insect detection system according to Third embodiment.

FIG. 9 is a block diagram illustrating a configuration of a server according to Third embodiment.

FIG. 10 is a schematic diagram illustrating an overall configuration of an insect detection system according to Fourth embodiment.

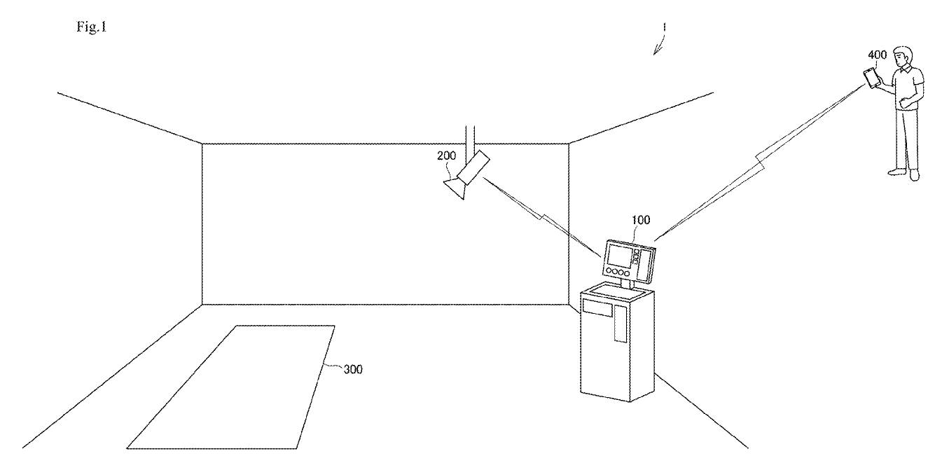

### DESCRIPTION OF EMBODIMENTS

The following describes embodiments of the present invention with reference to the accompanying drawings. In the following description, the same components are denoted by the same reference numerals. Their names and functions are also the same. Accordingly, detailed descriptions thereof of such elements will not be repeated.

### First Embodiment

### Overall Configuration and Operation Overview

First, an overall configuration and an operation overview of the insect detection system 1 according to the present embodiment will be described. The insect detection system 1 mainly includes a heat mat 300, an infrared camera 200, and a control computer 100.

A administrator or user of the system lays the heat mat 300 on the floor or attaches it to a wall before performing pest detection processing.

The infrared camera 200 includes an infrared sensor having several hundred by several hundred pixels. By capturing an image of the surface of the heat mat 300, the infrared camera 200 inputs infrared image data indicating a temperature distribution to the control computer 100.

In the present embodiment, the heat mat 300 is heated to a temperature higher than that of the surrounding floor or wall surface. Accordingly, when a cockroach or another insect is located on the heat mat 300, a portion having a lower temperature than the surrounding area of the heat mat 300 appears in the image captured by the infrared camera 200. Based on this, the control computer 100 can recognize that an insect such as a cockroach is present on the heat mat 300. In other words, the control computer 100 can detect that an insect such as a cockroach is present in the room.

Hereinafter, specific configurations of main components of the insect detection system 1 for realizing such functions will be described in detail.

### Configuration of Infrared Camera 200

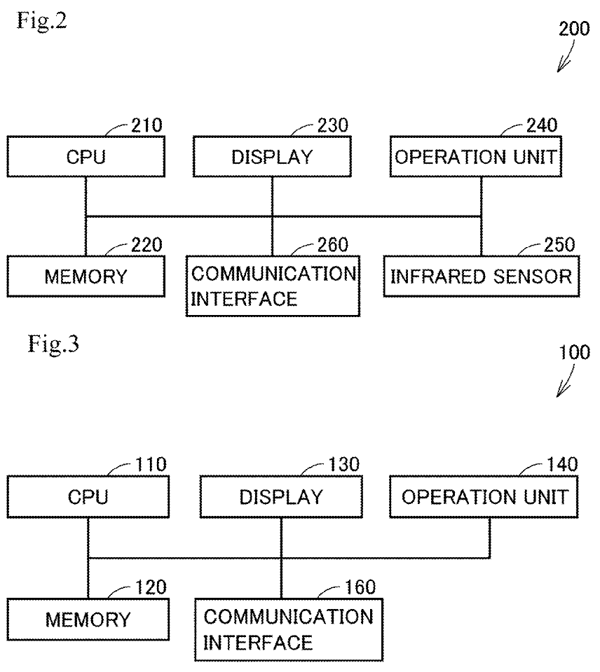

An exemplary configuration of the infrared camera 200 of the insect detection system 1 will be described. FIG. 2 is a block diagram illustrating one embodiment of the configuration of the infrared camera 200 according to the present embodiment.

Referring to FIG. 2, the infrared camera 200 includes, as its main components, a CPU (Central Processing Unit) 210, a memory 220, a display 230, an operation unit 240, an infrared sensor 250, and a communication interface 260.

The CPU 210 controls each unit of the infrared camera 200 by executing programs stored in the memory 220. The programs may be stored in an external storage medium.

The memory 220 includes various types of RAM (Random Access Memory), various types of ROM (Read-Only Memory), flash memory, and the like. The memory 220 may be used by the CPU 210 via an interface. The memory 220 may also include detachable storage media such as a USB (Universal Serial Bus) memory device, a CD (Compact Disc), a DVD (Digital Versatile Disc), a BD (Blu-ray Disc), and an SSD (Solid State Drive). The memory 220 stores programs executed by the CPU 210, infrared still image data and moving image data captured by the infrared sensor 250, and the like.

The display 230 outputs text and images based on signals from the CPU 210.

The operation unit 240 includes buttons, a touch panel, a keyboard, and the like. The operation unit 240 receives various instructions from a user and inputs those instructions to the CPU 210. The operation unit 240 may be configured as a touch panel in which the display 230 and the operation unit 240 are integrated or overlaid.

The infrared sensor 250 includes hundreds-by-hundreds of infrared detection sensors for detecting the intensity of infrared radiation at each frequency. The infrared sensor 250 inputs, to the CPU 210, the intensity at each frequency for each pixel. The CPU 210 generates infrared image data based on input signals from the infrared sensor 250 and stores the infrared image data in the memory 220.

The communication interface 260 exchanges data with other devices via wired or wireless communication. For example, the CPU 210 periodically or continuously transmits still image data and moving image data captured by the infrared sensor 250 to the control computer 100.

### Configuration of the Control Computer 100

Next, an embodiment of the configuration of the control computer 100 of the insect detection system 1 will be described. FIG. 3 is a block diagram illustrating an embodiment of the configuration of the control computer 100 according to the present embodiment.

Referring to FIG. 3, the control computer 100 includes, as its main components, a CPU 110, a memory 120, a display 130, an operation unit 140, and a communication interface 160.

The CPU 110 controls various units of the control computer 100 by executing programs stored in the memory 120. More specifically, the CPU 110 executes various processes described later by executing programs stored in the memory 120 while referring to various data stored in the memory 120.

The memory 120 includes various types of RAM, various types of ROM, flash memory, and the like. The memory 120 may also include a removable storage medium that is detachably connected to the control computer 100 via an interface. The memory 120 stores programs executed by the CPU 110, data generated by execution of programs by the CPU 110, data input from external sources, infrared image data acquired from the infrared camera 200, and the like.

In the present embodiment, prior to performing the actual insect detection process, a large number of still images and moving images in which insects such as cockroaches are present on the heat mat 300, as well as still images and moving images in which insects are not present on the heat mat 300, are input in advance as training data. That is, the CPU 110 performs deep learning in advance by receiving still images or moving images showing insects such as cockroaches present on the heat mat 300, still images or moving images showing no insects present on the heat mat 300, and determination results indicating the presence or absence of insects.

The display 130 displays text and images based on signals from the CPU 110.

The operation unit 140 includes buttons, a touch panel, a keyboard, and the like. The operation unit 140 receives various instructions from a user and inputs those instructions to the CPU 110. The operation unit 140 may be configured as a touch panel in which the display 130 and the operation unit 140 are integrated or overlaid.

The communication interface 160 exchanges data with other devices via wired or wireless communication. For example, the CPU 110 transmits various commands to the infrared camera 200 via the communication interface 160, and periodically or continuously receives still image data and moving image data captured by the infrared camera 200 via the communication interface 160. In addition, the communication interface 160 may exchange data with an external server and a communication terminal 400 via the Internet, a router, a base station, or the like.

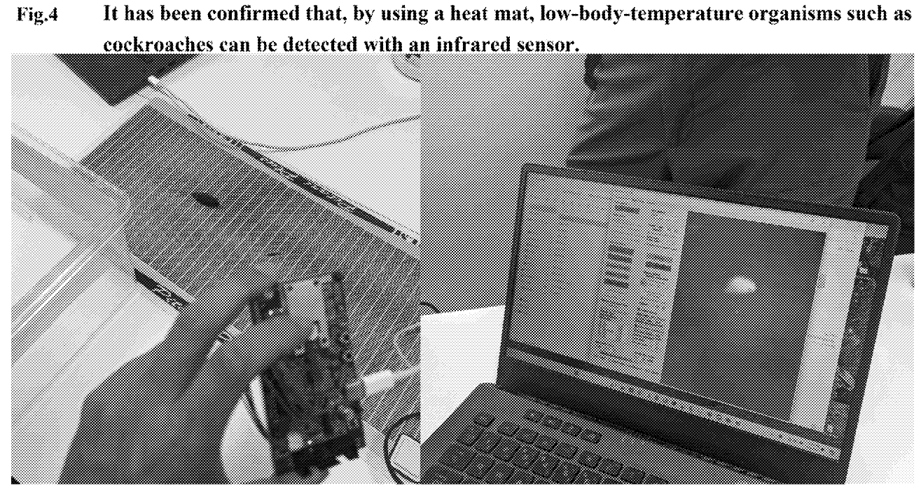

With the configuration described above, as shown in FIG. 4, in the present embodiment, the CPU 110 is capable of detecting a cockroach or other pest having a temperature lower than that of the heat mat 300 from the infrared image captured by the infrared camera 200.

### Information Processing in the Control Computer 100

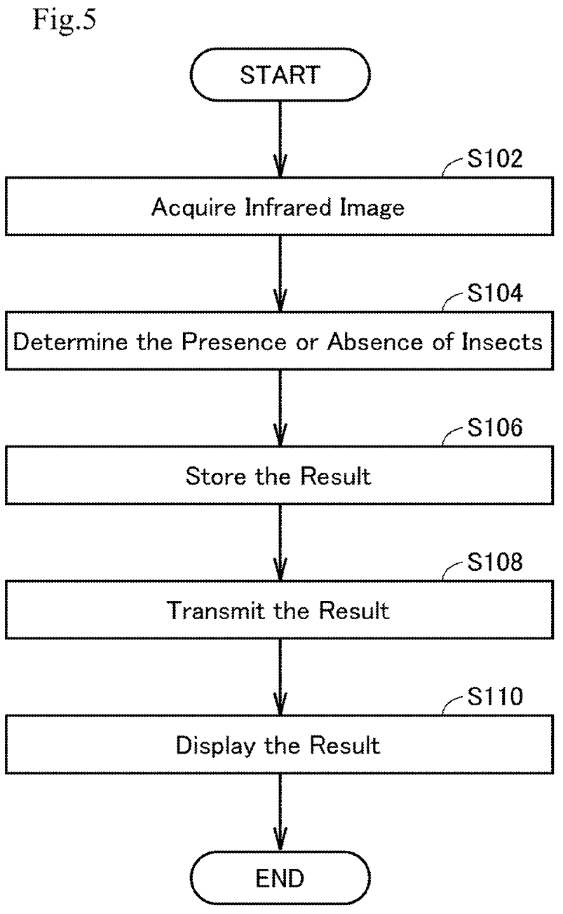

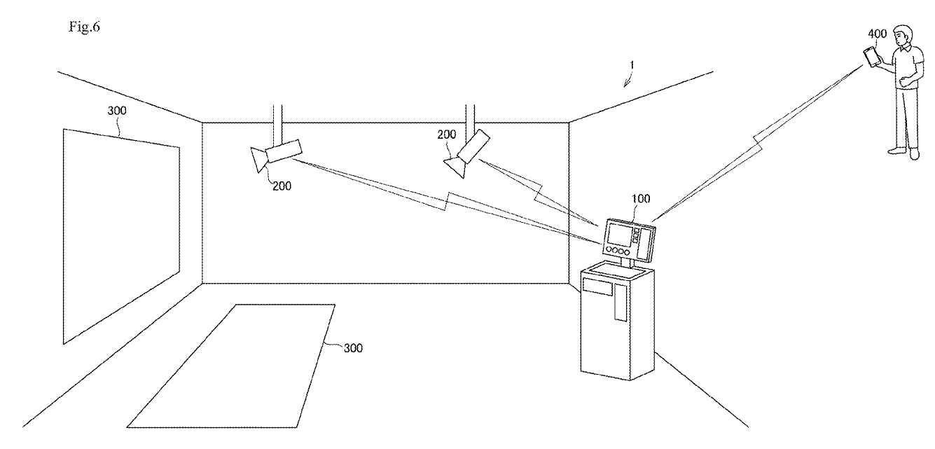

Next, information processing in the control computer 100 according to the present embodiment will be described. FIG. 5 is a flowchart illustrating the information processing performed by the control computer 100 according to the present embodiment. Specifically, after the user lays the heat mat 300 on the floor or attaches it to a wall, the control computer 100 starts the process. The CPU 110 of the control computer 100 executes a control program stored in the memory 120, thereby performing the processing shown in FIG. 5. It is preferable that the control computer 100 execute the following processing at night or when the room is dark.

The CPU 110 of the control computer 100 receives infrared image data from the infrared camera 200 via the communication interface 160 (Step S102).

The CPU 110 determines whether an insect such as a cockroach is included in the currently input infrared image by using the results of the deep learning (Step S104). The CPU 110 may determine the presence or absence of an insect on the heat mat 300 based on a single infrared still image. The CPU 110 may determine the presence or absence of an insects based on a plurality of infrared still images captured at intervals of several seconds or several minutes. The CPU 110 may determine the presence or absence of an insect based on an infrared moving image.

The CPU 110 stores the determination result in the memory 120 together with the imaging time (Step S106).

The CPU 110 may transmit the determination result to a communication terminal 400 of an administrator or a user via the communication interface 160 (Step S108).

Alternatively, after daybreak, the CPU 110 may display, on the display 130, information indicating whether a insect such as a cockroach were detected, based on an operation command from the administrator or the user (Step S110).

In this manner, according to the present embodiment, it becomes possible to detect the presence of insects such as cockroaches, which have relatively low body temperatures, by using an infrared camera 200.

### Second Embodiment

In the above embodiment, a single control computer 100 determines the presence or absence of insects based on infrared image data from a single infrared camera 200. However, the present invention is not limited to such a configuration.

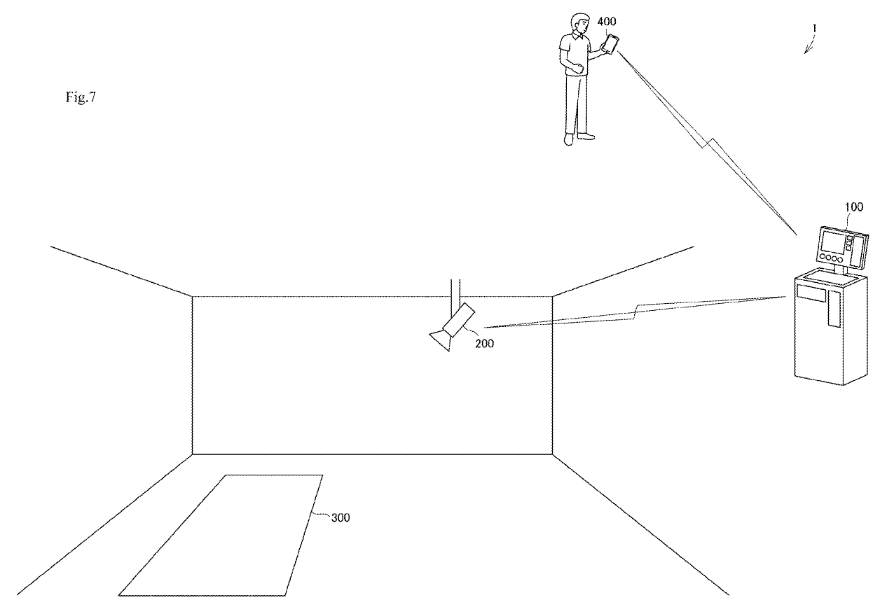

For example, as shown in FIG. 6, two or more heat mats 300, 300, … may be arranged on the floor, walls, or the like within a room. In addition, infrared cameras 200, 200, … for capturing images of the respective heat mats 300, 300, … may be disposed on the ceiling, walls, or the like.

In this case, the CPU 110 of the control computer 100 receives infrared image data from each of the plurality of infrared cameras 200, 200, …. The CPU 110 then executes the processing shown in FIG. 5 based on the still image data or moving image data from each infrared camera 200, thereby determining whether a cockroach or other insect is present on the corresponding heat mat 300, 300. The CPU 110 may store the determination results in the memory 120 together with the imaging location and imaging time. The CPU 110 may display the results on the display 130 or provide the results to the user’s communication terminal 400.

### Third Embodiment

In the above embodiment, the presence or absence of insects is determined by the control computer 100 disposed in the same room as the heat mat 300 and the infrared camera 200. The present invention is not limited to such a configuration.

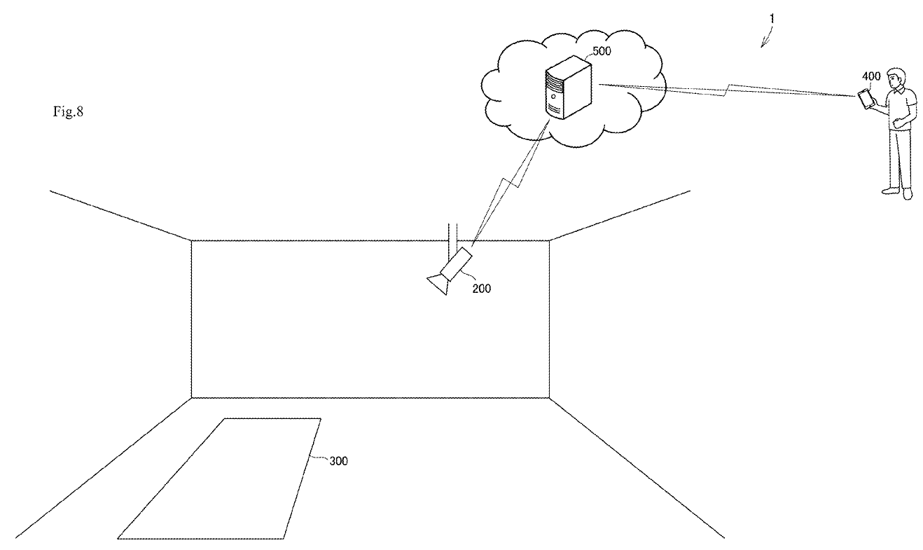

For example, as shown in FIG. 7, the control computer 100, which is disposed in a room or building different from the room or building in which the heat mat 300 is installed, may determine the presence or absence of insects such as cockroaches based on infrared image data transmitted from the infrared camera 200, as in the above-described embodiment. Alternatively, a control computer 100 that is communicatively connected to the infrared camera 200 and disposed in a room or building different from the room or building in which the infrared camera 200 is installed may determine the presence or absence of insects such as cockroaches based on infrared image data received from the infrared camera 200, as in the above-described embodiment.

Alternatively, as shown in FIG. 8, a cloud server 500 that is communicatively connected to the infrared camera 200 via the Internet or the like may perform the role of the control computer 100.

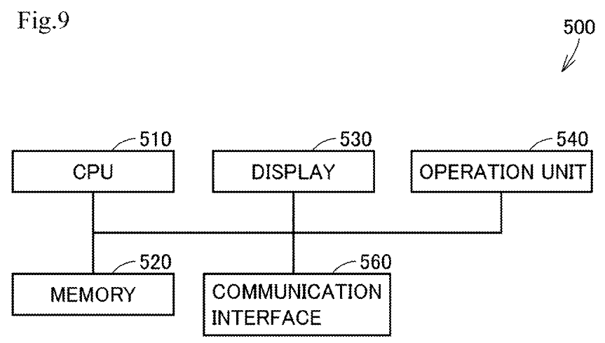

More specifically, referring to FIG. 9, the server 500 includes, as main components, a CPU 510, a memory 520, a display 530, an operation unit 540, and a communication interface 560. In the present embodiment, prior to the actual insects detection process, a large number of still images and moving images are input to the server 500 in advance as training data. The still images and moving images include images in which insects such as cockroaches are present on the heat mat 300 and images in which no such insects are present on the heat mat 300. That is, the CPU 510 performs deep learning in advance by receiving a large number of still images and moving images corresponding to cases where insects such as cockroaches are present on the heat mat 300 and cases where no such insects are present.

Next, information processing in the server 500 according to the present embodiment will be described. Referring to FIG. 5, the CPU 510 of the server 500 receives infrared image data from the infrared camera 200 via the Internet by using the communication interface 560 (step S102).

The CPU 510 determines, by using deep learning, whether the newly input infrared image includes a insects such as a cockroach (step S104).

The CPU 510 stores the determination result together with the imaging time in the memory 520 (step S106).

The CPU 510 transmits the determination result to the administrator’s communication terminal 400 via the communication interface 560 (step S108).

### Fourth Embodiment

The processing performed by the control computer 100 or the server 500 described above may alternatively be executed by a smartphone, tablet, or other device capable of receiving infrared image data from the infrared camera 200.

Alternatively, the infrared camera 200 and the control computer 100 may be incorporated into the same device. The insect detection system 1 may be realized by a single device. For example, the CPU 210 of the infrared camera 200 may execute a program stored in the memory 220 to perform the processing of the CPU 110 of the control computer 100 described in the above embodiment.

Referring to FIG. 5, the CPU 210 of the infrared camera 200 acquires infrared image data using the infrared sensor 250 (step S102).

The CPU 210 determines whether the infrared image captured this time includes an insect such as a cockroach (step S104).

The CPU 210 stores the determination result in the memory 220 together with the imaging time (step S106).

The CPU 210 may transmit the determination result to the administrator’s communication terminal 400 via the communication interface 260 (step S108).

Alternatively, after daybreak, the CPU 210 may display, on the display 230, information indicating whether insects such as cockroaches have been detected, in response to an operation command from the administrator (step S110).

Alternatively, an air conditioner, a refrigerator, or other electrical appliances may incorporate the functions of the infrared camera 200 and the control computer 100. In this case, the CPU of the electrical appliance may execute the processes of steps S102 to S110 described above based on infrared image data captured using the infrared sensor 250 mounted in the electrical appliance.

### Fifth Embodiment

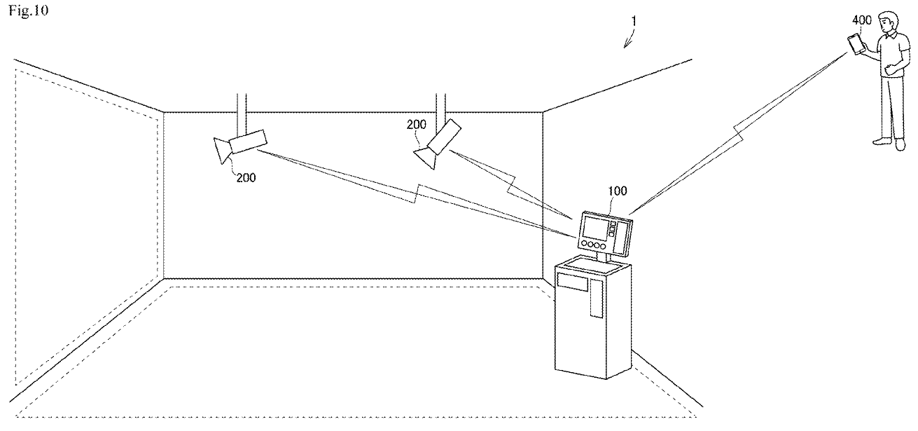

In the above-described embodiment, the heat mat 300 is arranged on a floor or wall, and the surface of the heat mat 300 is captured by the infrared cameras 200. However, the present invention is not limited to this configuration. As shown in FIG. 10, the floor or wall itself may be directly heated, such as in the case of floor heating or wall heating. In other words, the infrared cameras 200, 200, ... may directly capture infrared images of the floor or wall itself.

Alternatively, the heat mat 300 may be embedded beneath the floor. A glass plate, sheet, or the like may be laid over the heat mat 300. The infrared camera 200 captures an image of the surface of the area where the heat mat 300 is arranged. The control computer 100 or the server 500 may determine whether the infrared image includes an insect such as a cockroach.

### Review

In the above-described embodiment, there is provided an insect detection system including a heat mat, an infrared camera, and a computer. The infrared camera has a plurality of pixels. The infrared camera is pointed at the heat mat. The computer detects the presence of an insect based on a distribution of temperatures of the plurality of pixels acquired from the infrared camera.

In the above-described embodiment, there is provided an insect detection method including acquiring, using an infrared camera, a temperature distribution on the heat mat, and determining, by a computer, that an insect is present based on the temperature distribution.

Preferably, the insect detection method further includes attaching the heat mat to a floor or a wall of a room.

Preferably, the insect detection method further includes loading teacher data relating to a temperature distribution corresponding to a state in which an insect is present on the heat mat and performing deep learning based on the teacher data.

In the above-described embodiment, there is provided a computer including a communication interface and a processor. The communication interface communicates with the infrared camera. The processor acquires, via the communication interface, a distribution of temperatures of a plurality of pixels from the infrared camera. The processor detects the presence of an insect based on the temperature distribution.

In the above-described embodiment, there is provided a computer program for causing a processor to execute acquiring a distribution of temperatures of a plurality of pixels from an infrared camera and detecting the presence of an insect based on the temperature distribution.

It should be considered that the embodiments disclosed this time are illustrative in all respects and not restrictive. The scope of the present invention is indicated by the scope of the claims rather than the above description, and is intended to include all modifications within the scope and meaning equivalent to the scope of the claims.

### REFERENCE SIGNS LIST

1: Insect Detection System
100: Control Computer
110: CPU (Central Processing Unit)
120: Memory 130: Display
140: Operation Unit
160: Communication Interface
200: Infrared Camera
210: CPU
220: Memory
230: Display
240: Operation Unit
250: Infrared Sensor
260: Communication Interface
300: Heat Mat
400: Communication Terminal
500: Server
510: CPU 510
520: Memory
530: Display
540: Operation Unit
560: Communication Interface

What is claimed is:

1. An insect detection system, comprising:
a heat mat;
an infrared camera having a plurality of pixels and directed toward the heat mat; and
a computer configured to detect a presence of an insect based on a temperature distribution of the plurality of pixels acquired from the infrared camera.

2. An insect detection method comprising:
acquiring a temperature distribution on a heat mat by using an infrared camera; and
determining, by a computer, that an insect is present based on the temperature distribution.

3. The insect detection method according to claim 2, further comprising:
attaching the heat mat to a floor or a wall of a room.

4. The insect detection method according to claim 2, further comprising:
performing deep learning by inputting training data relating to a temperature distribution in a state in which an insect is present on the heat mat.

5. A computer comprising:
a communication interface configured to communicate with an infrared camera; and
a processor configured to acquire, via the communication interface, a temperature distribution of a plurality of pixels from the infrared camera and to detect a presence of an insect based on the temperature distribution.

6. A computer program for causing a processor to execute:
acquiring a temperature distribution of a plurality of pixels from an infrared camera; and
detecting a presence of an insect based on the temperature distribution.
